(19) United States
(12) Patent Application Publication
(10) Pub. No.: US 2007/0286597 A1
(43) Pub. Date: Dec. 13, 2007

(54) Magnetic fluid adjustable optical iris

(76) Inventor: William Hopper, Kensington (AU)

Correspondence Address: John L. Sotomayor, Suite 300, 511 Davis Drive, Morrisville, NC, 27560, US

(21) Appl. No.: 11/448,079

(22) Filed: Jun. 7, 2006

(51) Int. Cl. G03B 9/02

(52) U.S. Cl. 396/506

(57) ABSTRACT

Cameras such as electronic video surveillance cameras use an iris to adjust the total amount of light reaching the sensor element. An electrically adjustable iris composed of a magnetic fluid disposed within an aperture construction assembly allows the optical aperture to be adjusted dynamically and allows for more rapid change to optimum aperture settings for varying external lighting conditions.

### TECHNICAL FIELD

This invention relates to an electrically adjustable optical iris for use in optical devices such as cameras. Cameras such as those used in electronic video surveillance systems use an iris to adjust the total amount of light reaching the sensor element. An electronically adjustable iris allows the optical aperture to be adjusted dynamically and allows a light sensitive medium or sensor to operate within its optimum conditions with varying external lighting conditions.

### BACKGROUND

Currently available electrically adjustable iris assemblies are mechanical assemblies with moving and sliding parts. These assemblies use a servo controlled solenoid or motor and moving parts to provide an adjustable aperture through which the light passes. A significant disadvantage of existing devices is mechanical durability and ruggedness. Ruggedness and mechanical reliability are particularly important for use in mobile applications or environments exposed to vibration, shock, or extreme temperatures. In addition, overcoming mechanical latency in the movement of currently existing iris assemblies places a limit upon how quickly an iris can respond to changes in light conditions. With no moving parts, and, therefore, no mechanical latency to overcome, this invention can be manufactured to be more sensitive to changes in light conditions, responding more quickly and with greater reliability than an equivalent mechanical assembly.

### SUMMARY OF THE INVENTION

This invention relates to an optical iris with in which the mechanical moving parts are replaced by an optically opaque homogeneous magnetic fluid, such as magneto-rheological fluids that are known in the art, confined within a transparent aperture construction forming the iris of an optical device. This aperture construction is enclosed within a ring magnet. Through the application of an additional electrically induced magnetic field, the magnetic fluid can be caused to deflect and adjust the diameter of the optical aperture, forming an electrically adjustable iris assembly.

### BRIEF DESCRIPTION OF THE FIGURES

FIG. 1: Transparent aperture construction assembly

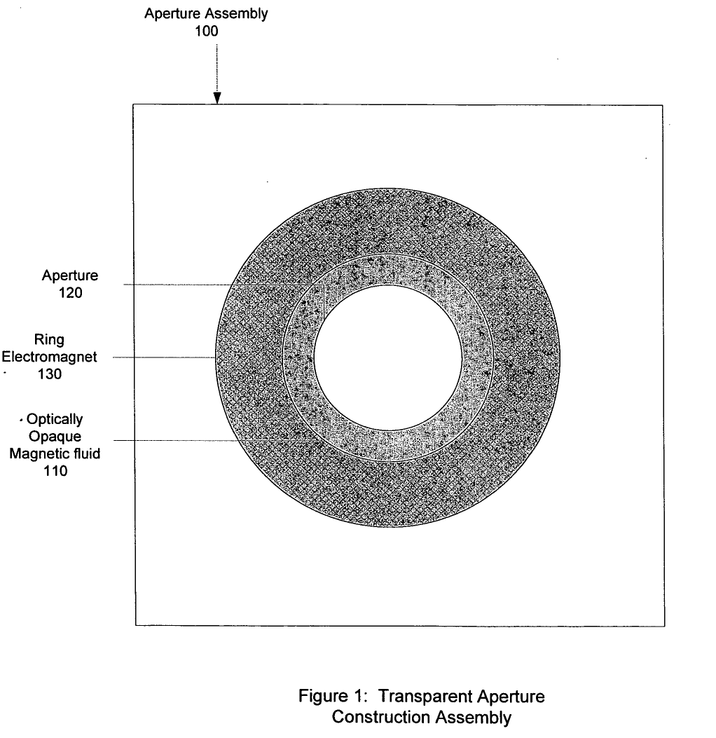

FIG. 2: Iris assembly: magnetic field not applied

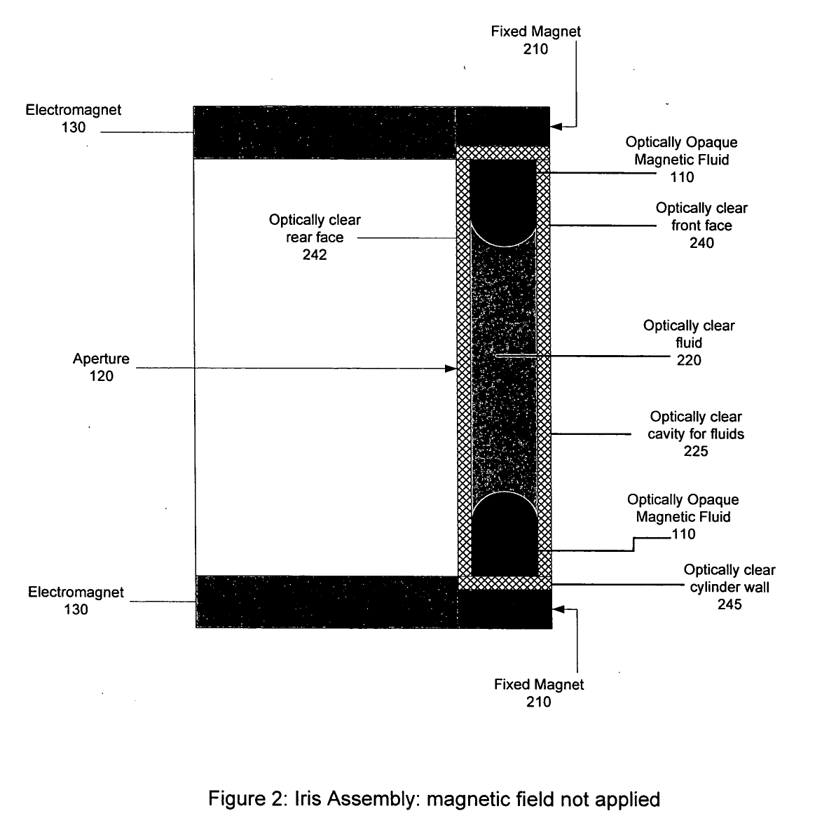

FIG. 3: Iris assembly: magnetic field applied

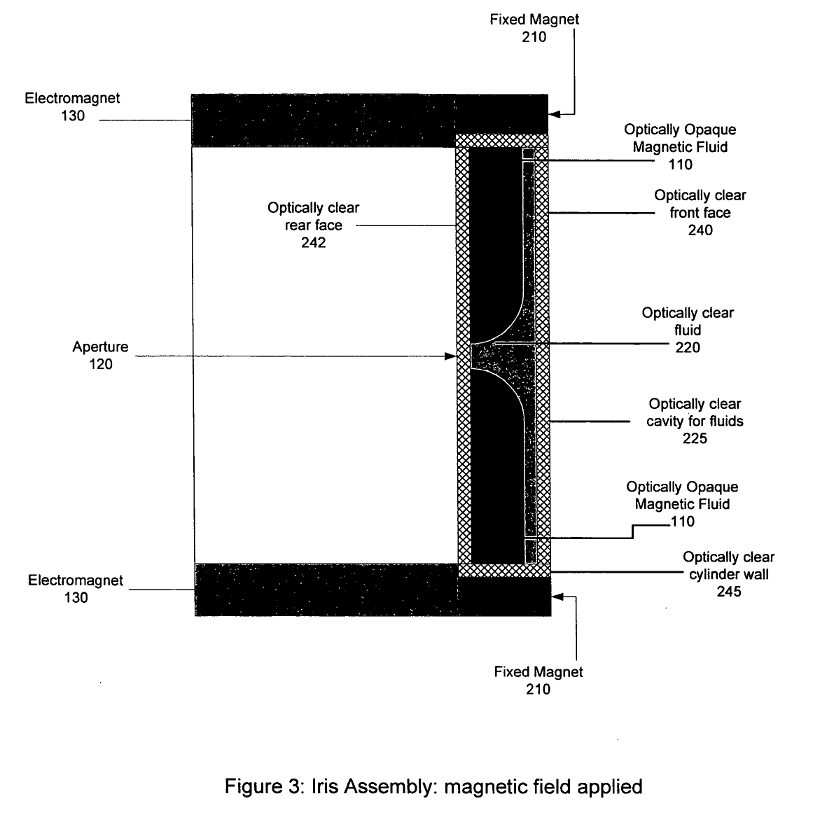

### DETAILED DESCRIPTION OF THE INVENTION

In the present invention, a transparent aperture construction consists of at least two clear plates (240, 242) and a cylindrical side wall 245 of a transparent medium such as glass, acrylic, or other optically clear material. In the preferred embodiment the clear plates (240, 242) and cylindrical side wall 245 are optically clear glass plates which are configured to form an enclosed cavity 225. An optically opaque homogeneous magnetic fluid 110 is confined within the optically clear cavity 225. In the preferred embodiment, a second, optically clear material 220 that does not mix with the homogeneous magnetic fluid 110 is confined within the same cavity 225. The second, optically clear material 220 may be a liquid, or a gas such as dry nitrogen. In another embodiment, the homogeneous magnetic fluid 110 is the only fluid present in the cavity which has been evacuated to form a vacuum and fills only a portion of the evacuated cavity space 225.

The aperture construction 100 is enclosed within a ring electromagnet 130 that is disposed about the entire circumference of the aperture construction 100 and the integral cavity 225. The ring electromagnet 130 acts with magnetic force on the homogeneous magnetic fluid 110 within the integral cavity 225 such that the homogeneous magnetic fluid 110 forms an annular ring with an optically clear center aperture 120 through the redistribution of the homogeneous magnetic fluid 110 within the cavity 225. In this way, a well defined circular aperture 120 is formed within the aperture construction cavity 225, the aperture 120 serving to form an iris for the admittance of at least the visible portion of the electromagnetic spectrum.

A coil of electrically conductive wire such as a cylindrical coil placed axially along the side of the aperture construction assembly 100 can apply a secondary magnetic force on the magnetic fluid 110 when an electric current is passed through the wire. The force on the magnetic fluid 110 is proportional to the number of turns and the electrical current applied to the coil. The addition of the secondary electromagnetic force deflects the homogeneous magnetic fluid 110 and causes the diameter of the optical aperture 120 to change, either increasing or decreasing the diameter of the aperture at the center of the annular ring of magnetic fluid 110, in proportion to the current applied to the cylindrical coil 130.

With an external electrically induced magnetic field applied the additional magnetic field, exerted upon the homogeneous magnetic fluid 110, causes the optical aperture 1120 diameter to be reduced. The redistribution of the homogeneous magnetic fluid 110 is in reaction to the applied electric power increasing the magnetic field of the electromagnet 130 and pulling the homogeneous magnetic fluid 110 in toward the ring electromagnet 130. By adjusting the strength of the electric current in the coil through the action of an electronic control circuit the diameter of the aperture 120 of the iris can be electrically controlled. The electronic control circuit is also connected to a feedback loop to the ring electromagnet 130 such that the current applied may be monitored and dynamically changed to maintain a desired aperture 120 opening diameter.

The electronic control circuit may also be electrically connected to an external optical sensor. This external optical sensor may be used to detect lighting conditions external to the aperture assembly construction and send light level data to the electronic control circuit. The light level data is used by the electronic control circuit to test against threshold values previously stored within the electronic control circuit. When threshold values are detected, the electronic control circuit will dynamically modify the amount of electrical current supplied to the ring electromagnet to modify the diameter of the aperture opening to achieve a pre-set aperture 120 diameter setting for each sensor threshold level.

In addition, a default aperture opening diameter may be achieved by the introduction of a second ring magnet 210 with a known magnetic force level. Placing the second ring magnet 210 axially separated from the first ring electromagnet 130 produces an aperture 120 opening calibrated to be proportional to the separation distance between the two ring magnets (130, 210). The use of the manual configuration of two ring magnets (130, 210) can be used to configure the default aperture 120 setting when no other magnetic field is present or no electric current is applied to the electric coil of the ring electromagnet 130.

The present invention is compatible with input power signals from existing power supplies such as those motor inputs that may be used to stimulate mechanical iris assemblies and are well known in the art.

While this invention has been particularly shown and described with reference to preferred embodiments thereof, it will be understood by those skilled in the art that various changes in form and details may be made therein without departing from the spirit and scope of the invention as defined by the appended claims.

We claim:

1. An aperture control system for an optical sensor device comprising:
a ring-shaped electromagnet disposed about an optically transparent aperture construction;
said optically transparent aperture construction further comprising an optically clear cavity with a front face, rear face, and cylindrical sidewall that are composed of materials that are optically clear and magnetically permeable, and providing a cavity within the interior of said construction;
said cavity containing at least one homogeneous fluid;
an electric power source;
an electronic control circuit electrically connected to said power source;
wherein said electronic control circuit is operational to control the amount of power received at said ring-shaped electromagnet.

2. An aperture control system for an optical sensor device according to claim 1 further comprising:
Said ring-shaped electromagnet fully encircles said optically transparent aperture construction, and
There is no generated magnetic field when there is no electrical power applied to said ring-shaped electromagnet.

3. An aperture control system for an optical sensor device according to claim 1 further comprising:
A second ring-shaped magnet adjacent to said optically transparent aperture construction;
Wherein said second ring-shaped magnet is a permanent magnet calibrated for a default magnetic field strength.

4. An aperture control system for an optical sensor device according to claim 1 further comprising:
said optically transparent aperture construction being substantially cylindrical with a front face, a rear face, and a cylindrical wall;
said front face, rear face, and cylindrical wall being made of an optically and magnetically transparent medium such as glass, acrylic, or other optically clear material.

5. An aperture control system for an optical sensor device according to claim 1 further comprising:
said aperture construction cavity containing at least one optically opaque homogeneous magnetic fluid.

6. An aperture control system for an optical sensor device according to claim 1 further comprising:
Said aperture construction cavity containing at least two homogeneous fluids.

7. An aperture control system for an optical sensor device according to claim 6 further comprising:
Said at least two homogenous fluids further comprising at least one optically opaque homogeneous magnetic fluid, and at least one optically clear homogeneous fluid.

8. An aperture control system for an optical sensor device according to claim 5 further comprising:
Said aperture construction cavity containing at least one optically opaque homogeneous magnetic fluid disposed within an evacuated cavity.

9. An aperture control system for an optical sensor device according to claim 1 further comprising:
said electronic control circuit electrically configured to provide a level of electrical power to the ring-shaped electromagnet sufficient to contract said optically opaque homogeneous magnetic fluid to provide a circular aperture opening in said fluid with a diameter that is proportional to the electrical power level provided.

10. An aperture control system for an optical sensor device according to claim 9 further comprising:
an optical sensor external to said aperture assembly and electrically connected to said electronic control circuit;
means for modifying the diameter of the aperture under control of said electronic control circuit in response to signals received from said external optical sensor.
